(19) United States
(12) Patent Application Publication
(10) Pub. No.: US 2007/0007093 A1
(43) Pub. Date: Jan. 11, 2007

(54) Hydrodynamic retarder

(75) Inventor: Klaus Vogelsang, Crailsheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Voith Turbo GmbH & Co. KG

(21) Appl. No.: 10/568,909

(22) PCT Filed: Jul. 9, 2004
(86) PCT No.: PCT/EP04/07544

§ 371 Date: Aug. 24, 2006

(30) Foreign Application Priority Data
Aug. 19, 2003 (DE) 103 38 010.8

(51) Int. Cl. F16D 57/02

(52) U.S. Cl. 188/296

(57) ABSTRACT

A hydrodynamic retarder is provided having a rotor blade wheel, which has a number (Z_{R}) of blades, and a stator blade wheel, which has a number (Z_{S}) of blades. The rotor blade wheel and the stator blade wheel together form a toroidal working chamber in which torque is transmitted from the rotor blade wheel to the stator blade wheel by means of a working medium. The blades have a profile with an inner diameter (D_{I}) and an outer diameter (D_{A}). The mean number of the blades (Zₘ), which results from half of the sum of the number of rotor blades (Z_{R}) and the number of stator blades (Z_{S}) multiplied by the profile shift factor (f ᵥ) is fixed, depending on the working medium.

### CROSS-REFERENCE TO RELATED APPLICATIONS

This application claims the priority of International Patent Application No. PCT/EP2004/007544 filed on Jul. 9, 2004, which claims priority of German Patent Application No. 103 38 010.8 filed on Aug. 19, 2003, the entire contents of both of which are incorporated by reference herein.

### BACKGROUND OF THE INVENTION

1. Field of the Invention

The invention relates to a hydrodynamic retarder.

2. Description of Related Art

Retarders of this kind are known from numerous publications. Mentioned by way of example is DE 3,113,408 C1.

Research and development in the area of retarders has proceeded up to now mainly in terms of achieving a power density that is as high as possible during braking operation, while, during non-braking operation, the power input should be as small as possible. In accordance therewith, the construction design of retarders has occurred virtually exclusively in these terms.

Only a few publications deal with the noise production of retarders, particularly during braking operation. Reference in this regard is made to EP 0 634,584 B1, which describes a ratio of the number of blades in the rotor blade wheel to that of the stator blade wheel, which, in the case of oil retarders, that is, retarders in which oil is the working medium, is intended to lead to an especially low noise production. Described in said document are also secondary measures, which, as a rule, continue to be implemented at present in order to dampen the noise emission of a driveline having such a retarder.

It has been found that the measures described in EP 0 634,584 B1 are not adequate in order to keep low the average noise development in a large number of different retarder constructions. In particular, up to now, it has not been possible to understand adequately the variables having an influence on the noise development.

### BRIEF SUMMARY OF THE INVENTION

The invention is based on the problem of producing a hydrodynamic retarder that, in terms of noise development, is improved over known retarders. In so doing, the measures of the invention shall leave untouched the largest possible number of structural degrees of freedom.

The inventors have recognized that a suitable choice of the mean number of rotor blades of the retarder can substantially reduce the noise emission. Here, in this document, the mean number of rotor blades is understood to mean the arithmetic mean resulting from the number of rotor blades and the number of stator blades, that is, half of the sum of the number of rotor blades and the number of stator blades. In accordance with the invention, the so-called profile shift factor is taken into account at the same time. The profile shift factor describes the deviation of the radial position of the flow circulation of a given retarder in relation to the radial position of the flow circulation in a retarder having a so-called normal profile. In detail, the profile shift factor results from the division of the outer diameter of the “shifted profile” by the outer diameter of the normal profile. Accordingly, for example, the profile shift factor for an outer diameter of a profile that is twice as large as the outer diameter of a normal profile is 2. Insofar as the profile is not shifted in relation to a normal profile, that is, insofar as the outer diameter of the profile being evaluated coincides with the outer diameter of the normal profile, a profile shift factor of 1 results correspondingly.

The outer diameter of a normal profile is fixed by the ratio of the outer diameter to the inner diameter of the corresponding profile. A normal profile is exactly present when the inner diameter is about 0.4 times the outer diameter. A tolerance of 0.05 may be set; that is, the following formula applies for a normal profile:
D_{I}=0.4^{±0.05}×D_{A}.

In order to achieve an optimal noise reduction, the working medium of the respective retarder is taken into account in designing the mean number of blades. Thus, for oil as the working medium oil or for a working medium that consists of oil for the most part, a minimum noise emission results when the mean number of blades multiplied by the profile shift factor lies in the range of 22 to 25. It is especially advantageous when the mean number of blades multiplied by the profile shift factor is 23.5^{±0.35} for this working medium.

For water as the working medium or for a working medium that consists primarily of water, the optimal mean number of blades multiplied by the profile shift factor results in a number between 19 and 22. It is advantageous when the mean number of blades multiplied by the profile shift factor is 20.5^{±0.35} for the working medium water or a water mixture.

For both working mediums, especially good noise emission values result when the mean number of blades multiplied by the profile shift factor is 23.5 for oil and 20.5 for water.

In an advantageous enhancement of the invention, the number of blades is fixed at the same time on the basis of a relation between the number of rotor blades and the number of stator blades. It is especially advantageous for oil or an oil mixture as the working medium when the number of rotor blades is 1.35 times the number of stator blades. Here, too, it is advantageous to permit a tolerance of ±0.15 in relation to the factor mentioned; that is, the following relation results:
Z_{R}=1.35^{±0.15}×Z_{S}.

For water or a water mixture as the working medium, the number of rotor blades is advantageously 1.3 times the number of stator blades. Here, too, it is advantageous to permit a tolerance of ±0.15; that is, the following relation applies:
Z_{R}=1.3^{±0.15}×Z_{S}

The invention will be illustrated in greater detail below on the basis of drawings.

### BRIEF DESCRIPTION OF THE SEVERAL VIEWS OF THE DRAWINGS

FIG. 1 a retarder depicted schematically in longitudinal section;

FIG. 2 a sketch showing the essential dimensions of the rotor profile and of the stator profile of a retarder.

### DETAILED DESCRIPTION OF THE INVENTION

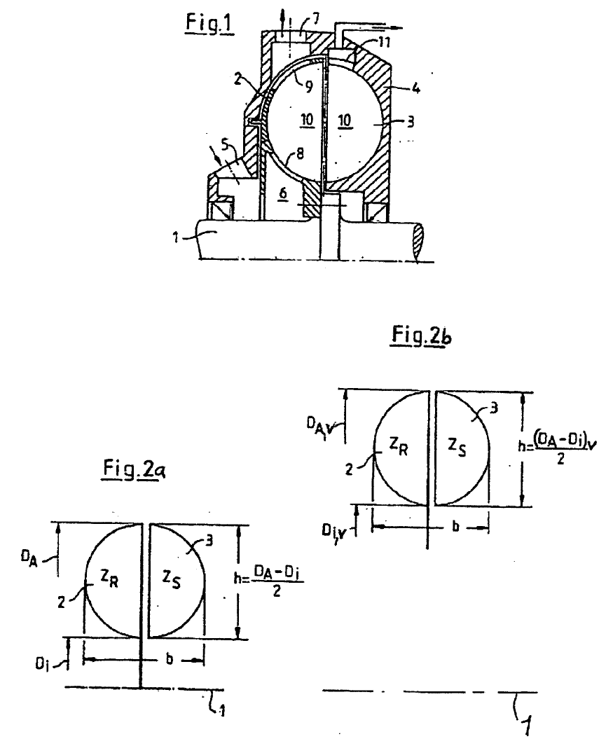

The retarder shown in FIG. 1 has a drive shaft 1, on which a rotor blade wheel 2 is keyed and, in addition, a stator blade wheel 3, which is arranged in a torsionally rigid manner in a housing 4. In the embodiment example shown, the working fluid is fed to the retarder through an inlet channel 5 via a control device that is not depicted. The working fluid first enters a distributing chamber 6. It is discharged further from an outlet channel 7. Filling slots 8 are evident in the inner region of the rotor blade wheel and draining slots 9 are evident in the radially outer region. The two blade wheels, that is, the rotor blade wheel and the stator blade wheel together form a toroidal working chamber 10.

The invention is not limited to the depicted embodiment of the retarder. Thus, in particular, the working medium can be fed via the stator or a stator housing to the working chamber 10. To this end, the stator housing is furnished advantageously with a radially inner-lying ring-shaped filling channel and a radially outer-lying, ring-shaped evacuation channel arranged next to it. Working medium is carried into the filling channel via a connecting piece and, from there, via holes or channels in the stator blades—in so-called filling blades—into the working chamber 10 and again via suitable holes in the stator out of the working chamber 10 into the evacuation channel. From there, the working medium is carried out of the retarder by means of suitable connections, in particular exactly one connection.

Here, particularly, an overhung mounting of the retarder comes into consideration.

FIG. 2 shows, among other things, the preferred values for the present invention. Thus, in FIG. 2a, the profiles of the rotor R and the stator S are pictured as a normal profile. They each have an outer diameter D_{A} and an inner diameter D_{I}. The inner diameter D_{I} is about 0.4 times the outer diameter D_{A}. The rotor has a number of blades Z_{R} and the stator has a number of blades Z_{S}.

Depicted in FIG. 2b is a retarder having a so-called shifted profile. In the present case, the profile is shifted radially outward in relation to a normal profile. The values that are thereby changed are marked in addition by the index V. The profile shift factor fᵥ results in the present case from the ratio of the outer diameter D_{A, v} of FIG. 2b to the outer diameter D_{A} of the profile in FIG. 2a.

As can be seen, the profile shift factor in FIG. 2b is about 2. It is also possible to shift the profile of a retarder radially inward in relation to the normal profile and, in this case, a profile shift factor that is smaller than 1 results.

The present invention having been thus described with particular reference to the preferred forms thereof, it will be obvious that various changes and modifications may be made therein without departing from the spirit and scope of the present invention as defined in the appended claims.

1. A hydrodynamic retarder, comprising:
a rotor blade wheel having a number Z_{R} of blades;
a stator blade wheel having a number Z_{S} of blades;
the rotor blade wheel and the stator blade wheel defining at least in part a toroidal working chamber in which torque is transmitted from the rotor blade wheel to the stator blade wheel by a working medium;
the blades having a profile with an inner diameter D_{I} and an outer diameter D_{A};
wherein
a mean number of the blades Zₘ, which results from half of the sum of the number of rotor blades Z_{R} and the number of stator blades Z_{S}, multiplied by the profile shift factor f ᵥ, which results from division of the outer diameter D_{A}, of a profile that is radially displaced relative to a normal profile by the outer diameter D_{A} of the normal profile, is fixed, depending on the working medium, wherein Zₘ is between 22 and 25 for a working medium of oil, in particular 23.5^{±0.35}, and between 19 and 22 for a working medium of water or a water mixture, in particular 20.5^{±0.35}, and wherein the normal profile is defined by the following relationship:
D_{I}=0.4^{±0.05}. D_{A}.

2. The hydrodynamic retarder according to claim 1, further characterized in that, for oil as a working medium, the number of rotor blades Z_{R} is 1.2 times to 1.5 times, in particular 1.35^{±0.15} times, the number of stator blades Z_{S} and, for water or a water mixture as the working medium, the number of rotor blades Z_{R} is 1.15 times to 1.45 times, in particular 1.3^{±0.15} times, the number of stator blades Z_{S}.
